(19) United States
(12) Patent Application Publication
(10) Pub. No.: US 2012/0229273 A1
(43) Pub. Date: Sep. 13, 2012

(54) Pretty paw detectables and detectable clothing apparel (analog, digital and global positioning detection)

(76) Inventors: Michael Douglas Rea Standing Bear, II, Gill, CO (US); Rosemary R. Bryant, Lakewood, CO (US)

(21) Appl. No.: 12/925,766

(22) Filed: Mar. 8, 2011

(51) Int. Cl. G08B 1/08

(52) U.S. Cl. 340/539.13

(57) ABSTRACT

Pretty Paw manufactures real time active tracking devices for family security, consisting of embedded chip, handheld portable units and a home base unit.

Tracking chips are embedded primarily in socks, and interface with the portable home base units which are purchased and sold separately.

Consumers activate the tracking chip by scanning the article into the portable or home base unit, which then automatically begins to display location and movement of the chip.

Pretty Paw software allows real-time determination of variable movement and location, tracking parameters; including line-of-sight and long range global positioning tracking, phone interface, emergency protocols and USB parameters.

Consumers utilize Pretty Paw technology to notify law enforcement of emergencies in real-time by providing instantaneous G.P.S. and significant probable cause to appropriate law enforcement computers and dispatch centers concerning individual adult and child abductions.

Pretty Paw adds the needed security for both family and our community.

### CROSS REFERENCES

1. Pretty Paw Detectables and Detectable Clothing Apparel is currently issued under application Ser. No. 12/925,766—USPTO

2. This submittal contains NEW MATTER. The current confirmation is:
i. 2090
   and shall reference any pending application bearing this application Ser. No. 12/925,766

### (a) New Matter

1. The dimension reflected differs from the original submittal. (see, figure drawing and descriptions.)

2. The wording in the summary and detail of the invention is amended.

3. There are no International Filings associated with this application.

### BACKGROUND

1. Pretty Paw Detectables and Detectable Clothing Apparel are designed and introduced as a primary security option for individual family and business use.

2. Pretty Paw detectables are embedded micro (flex) chips which are inserted into desirable articles of clothing. Pretty Paw offers two chips, one is circular and the other is rectangular. These chips both emit a single signature to the portable device or the home base unit in an effort to track the article of clothing. Pretty Paw works in conjunction with individual security and location of a loved one.

3. Pretty Paw detectables would decrease the 24 hr. window or commonly known “wait time” needed to initiate a nationwide alert system by providing probable cause to our local law enforcement agencies.

4. Pretty Paw detectables are unique as they offer both (LOS) line-of sight technology and (GPS) Global Positioning Satellite Location.

### SUMMARY OF THE INVENTION

1. Pretty Paw detectables and detectable clothing are individual and personal detection security options which will be open to the general public for retail sales. Pretty Paw detection will ensure the location of the wearer by sending an alert signal to either the hand held portable viewing device or home base unit. Either unit will be able to display the where-a-bouts of the chipped article of clothing (via) G.P.S. or L.O.S.

With this devise and technology will ultimately reduce issues concerning abductions and missing person reports. The chip is embedded within each article and is visually undetectable by the human eye or any man made detection devices, (e.g. metal detectors, wands etc.).

In todays busy society, access to abductions have made security our number one concern. Child and Adult location should be at the top of this list. Pretty Paw detectables, would restore the importance of this concern.

Although Pretty Paw can not tell the consumer “what” is going on with the person whos wearing and embedded chip, but what it can tell you is “where” the person is currently located geographically.

2. (LOS) TECHNOLOGY: Line-of-sight. This technology allows the consumer to pre program a specified yardage into the portable or home base unit. Any chipped article of clothing will alert the consumer if the article travels out side the designated pre-programmed range and automatically switch to GPS location in real time, giving the consumer ultimate security and reinforcement.

3. (GPS) TECHNOLOGY: Global Position System. This ability is currrently being used throughout the world and including automobile location and detection. With G.P.S., the consumer can rest assured that detection in real time is at his/her finger tips and where they may contact and alert local law enforcement of a possible abduction or missing person.

### An Ongoing Concern

1. Many government agencies, (local law enforcement) and in many of the states require a mandatory 24 hour notice or (waiting period) before the agency will begin and initiate a search of the missing person.

Statistics show, this window is to long and many times the (intended) victim has been violated or worse, subjected to a casualty. Pretty Paw, and working with local law enforcement and disaster relief division, will generate the much needed probable cause within this 24 hour local window rule and which would dramatically increase the recovery time.

The availability of this devise, law enforcement officials can alert and initiate the (AAS) Amber Alert System and increase recovery for first responders.

2. Disaster relief is also a huge concern in response and recovery time. We have experienced a hardship during our most recent natural disasters and terrorist attacks in our country. We currently use canines to detect our missing loved ones, but with Pretty Paw, the recovery time will be increased by at least, 80-90%.

3. Pretty Paw micro-chips are non-toxic and resistant to extreme wheather conditions. Each chip is designed to carry a battery life up to 3-5 years and can be easily replaced by installing a new chip.

Pretty Paw chips are virtually indestructible but can be deactivated by disrupting the signal (ie. Breaking the chip).

### DESCRIPTION

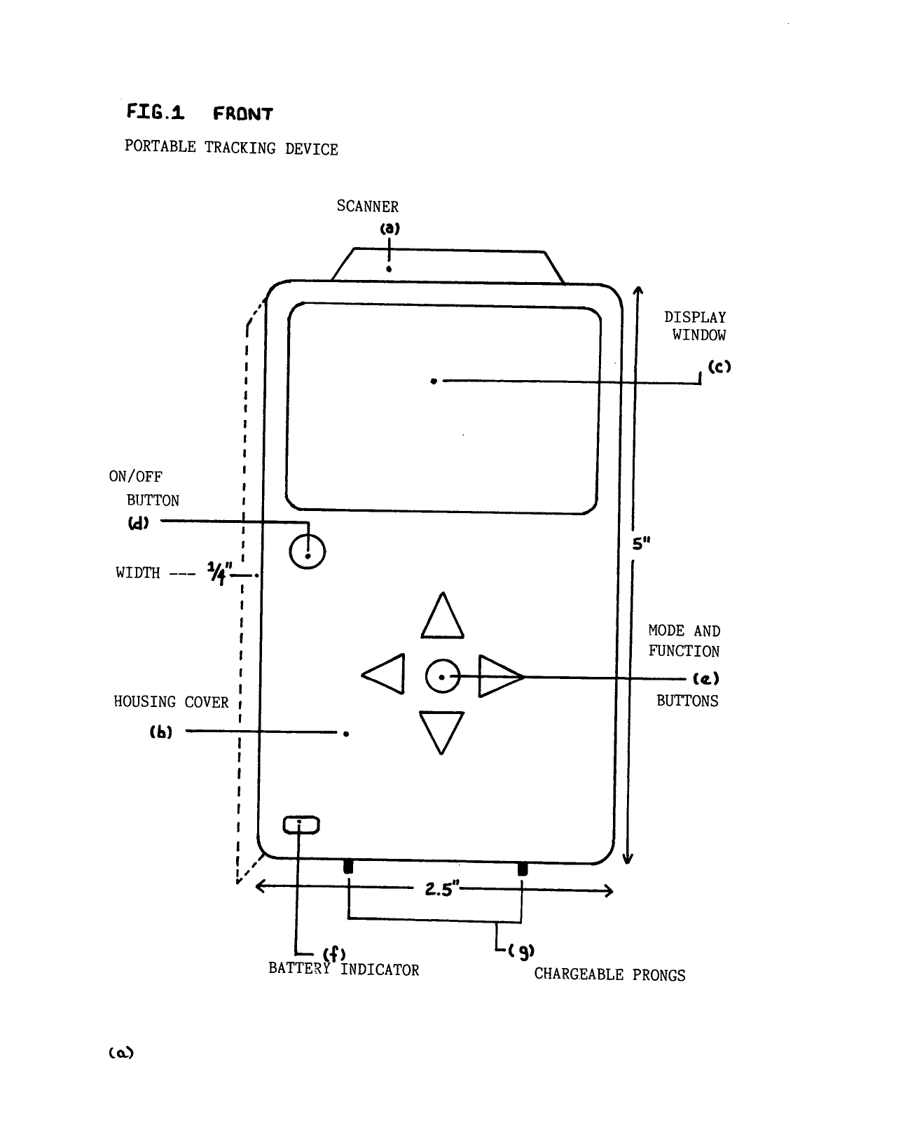

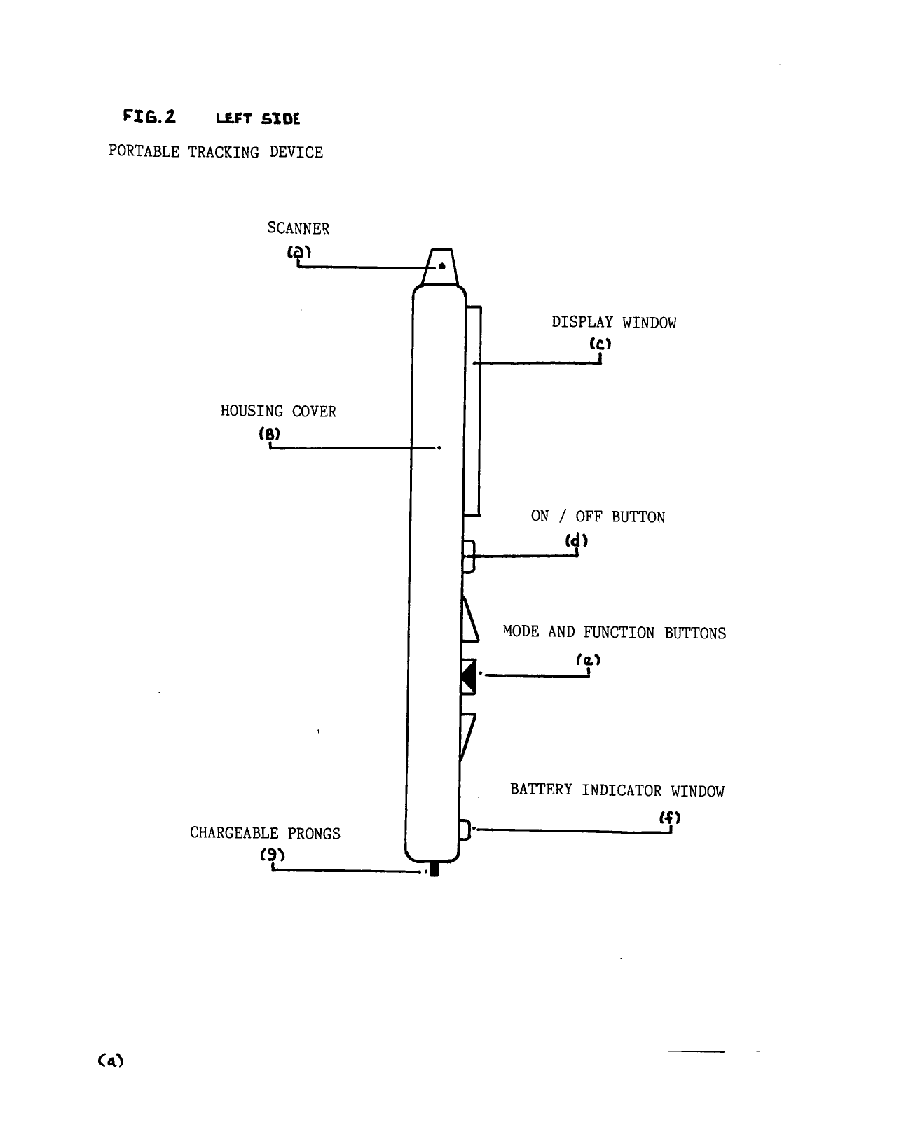

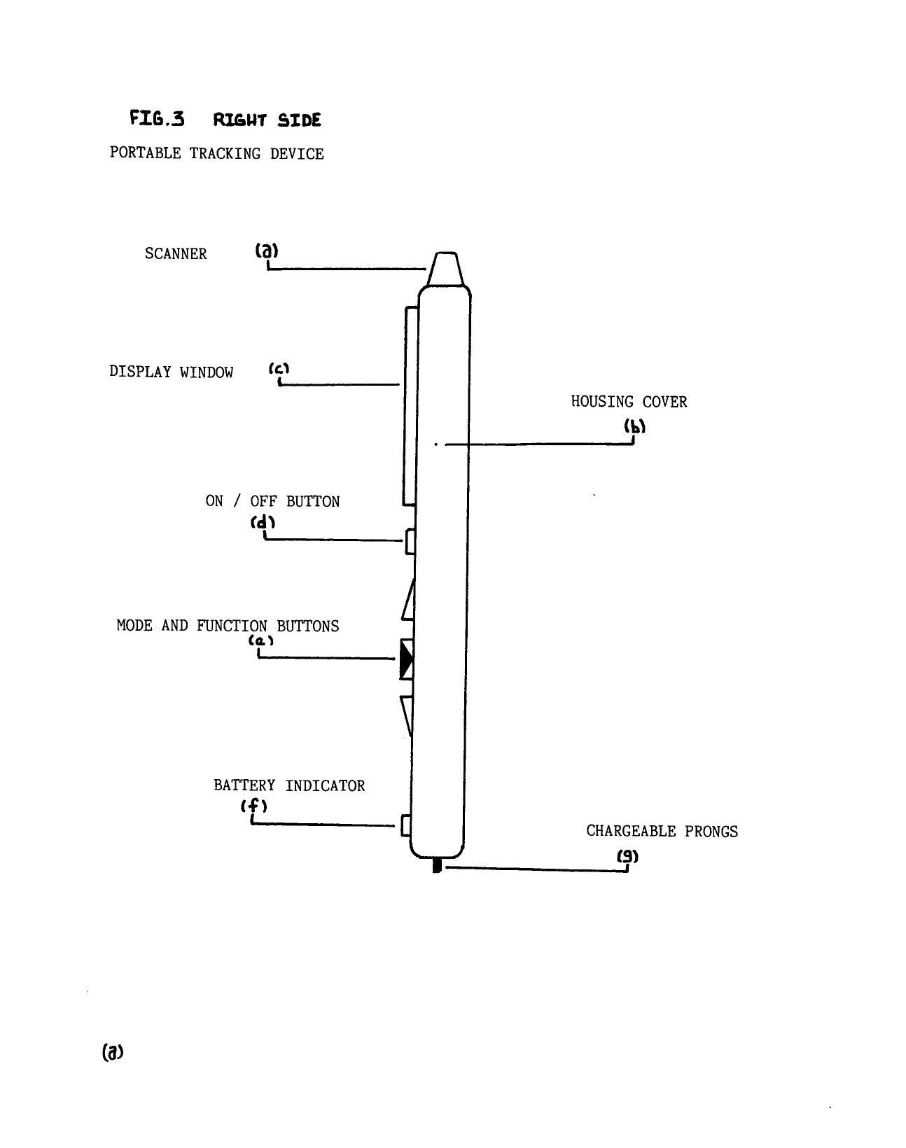

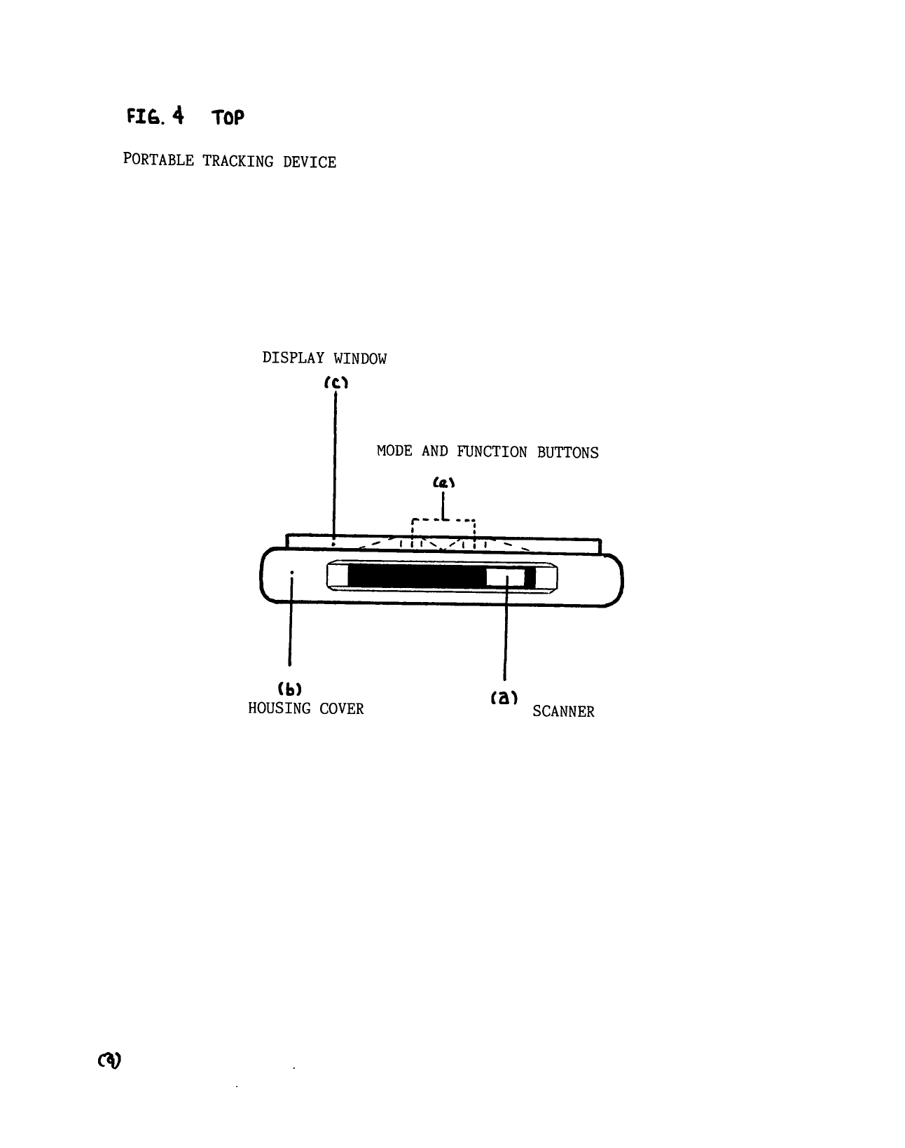

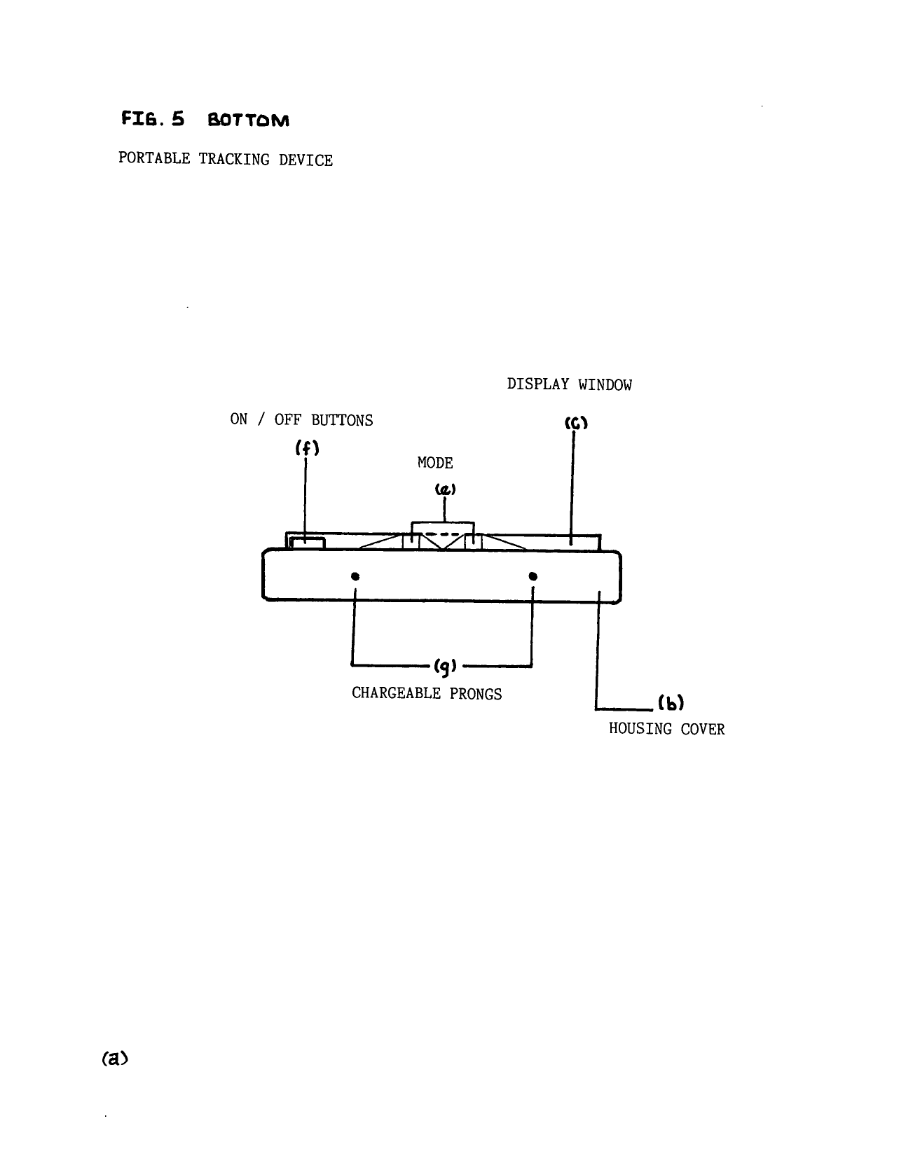

### FIG. 1 Portable Hand Held Tracking Device

Front View with Details
a. Chip Activator and Scanner:

i. Scan window which allows the consumer to activate the chip inserted in the desired article of clothing.

b. Unit Housing:

i. Portable unit cover and case.

c. Display Screen:

i. An L.E.D. screen which allows the consumer to visually inspect the location of the chipped article of clothing in either (LOS) Line-of-sight mode or, (GPS) Global Positioning Satellite (real time) mode.

d. On and Off Button:

i. Allows the consumer to turn on and off the portable device.

e. Mode and Function Button:

i. Allows the consumer to select viewing options and either (LOS) mode or (GPS) mode including the ability to track multiple individuals or by single reference.

f. Battery Life Indicator:

i. The window which indicates the life left in the current battery.

g. Chargeable Prongs:

i. Allows the consumer to place the device in the charging cradle to recharge the battery to its full capacity and strength.

### DETAIL DESCRIPTION OF THE INVENTION

1. Chips: Pretty Paw detectables consist of two types of micro-chips.

(i) Circular and (ii) Rectangular

a. CIRCULAR: Composition and Matter . . . Plastic/flex fiber
SIZE: . . . 2 cm dia.

POWER SOURCE: . . . WAFER
SIZE: . . . 1.5 cm dia.

COMBINED THICKNESS: . . . (approx.) 2 cm dia.

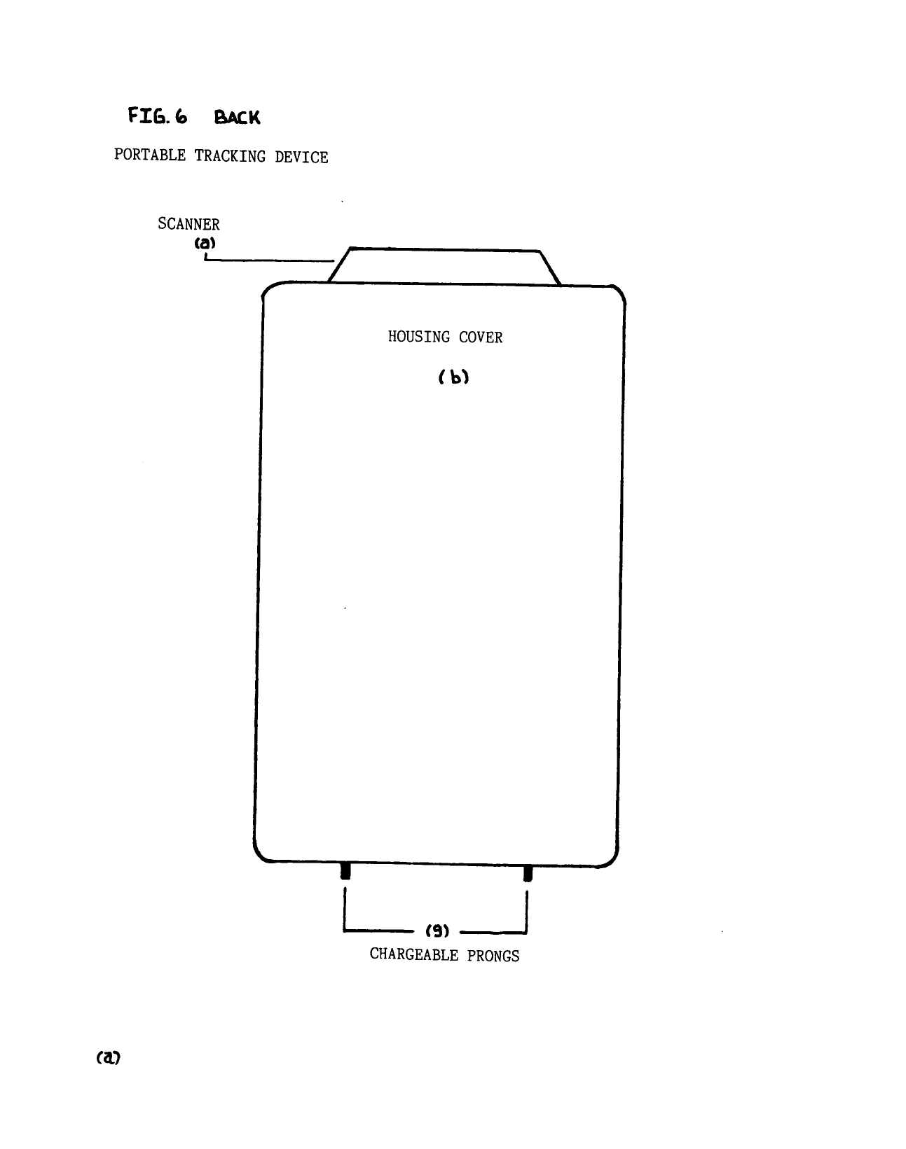

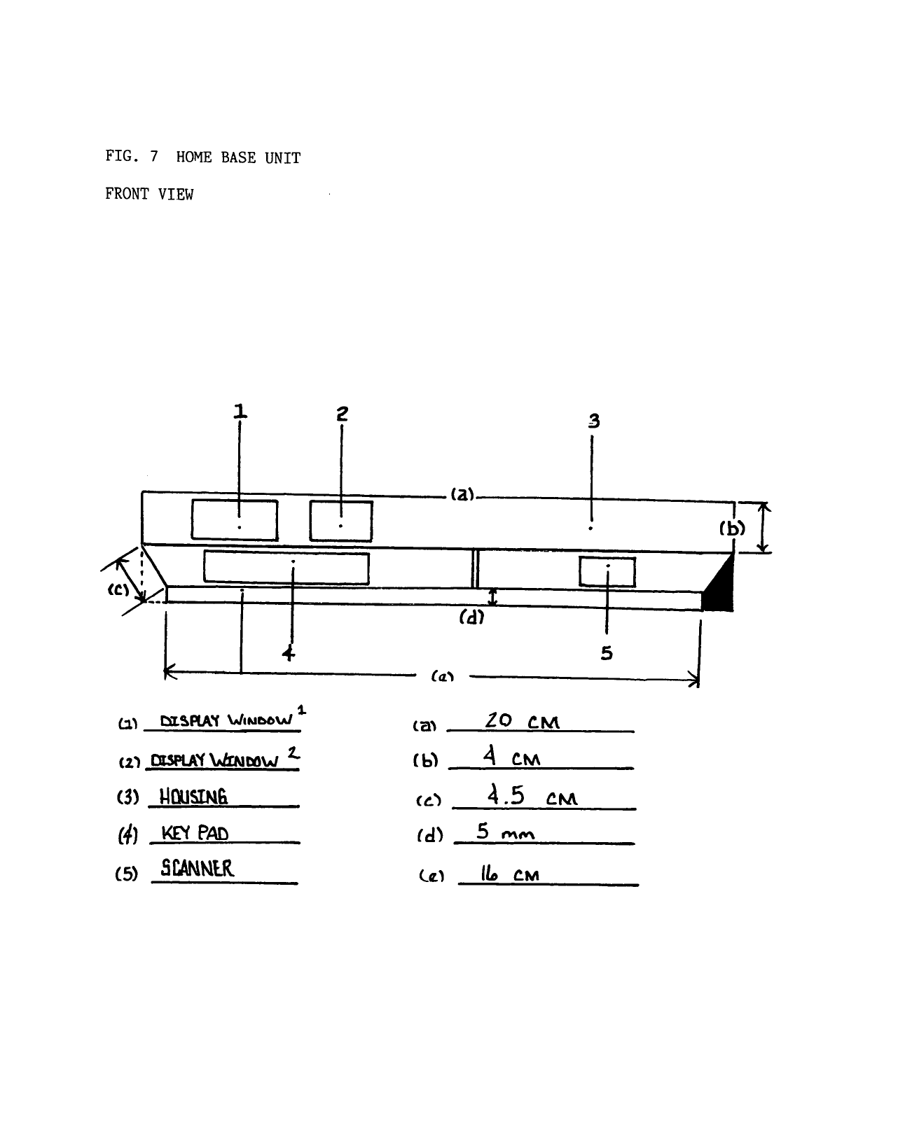

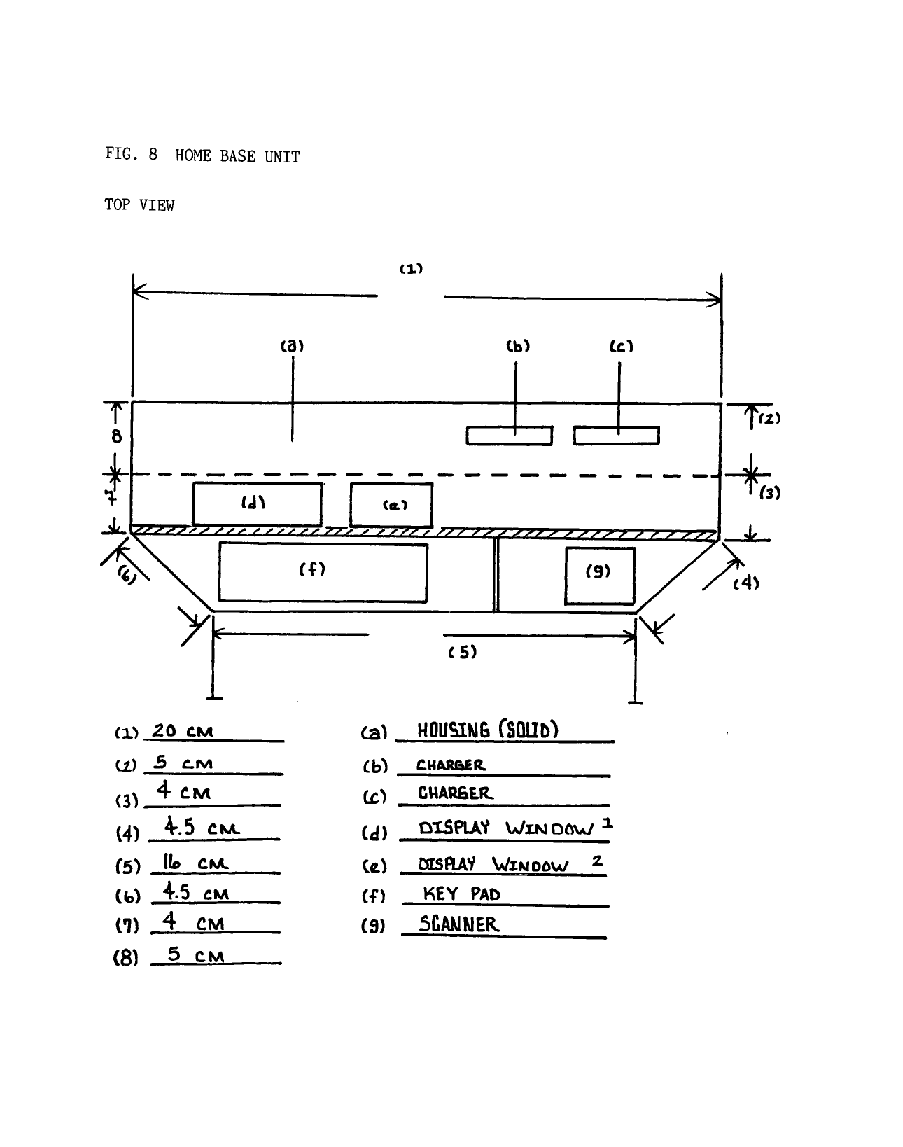

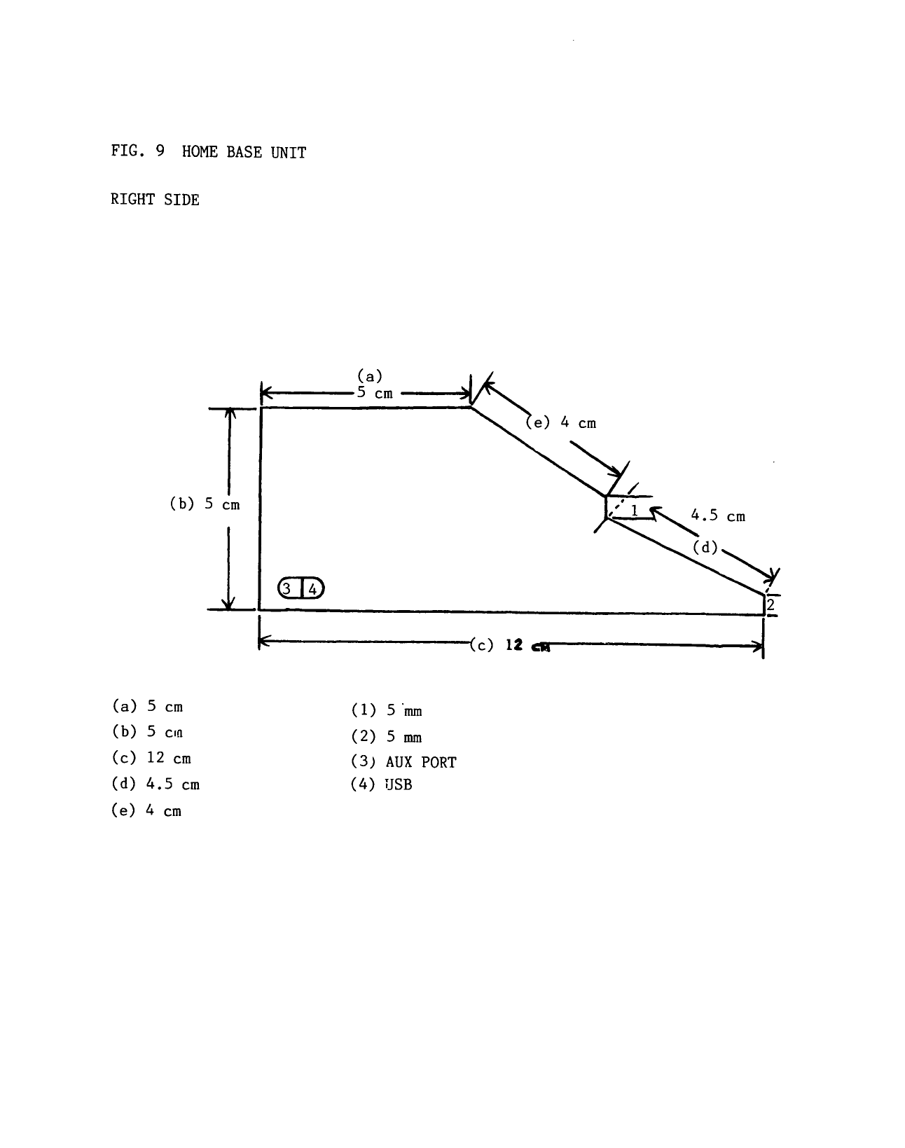

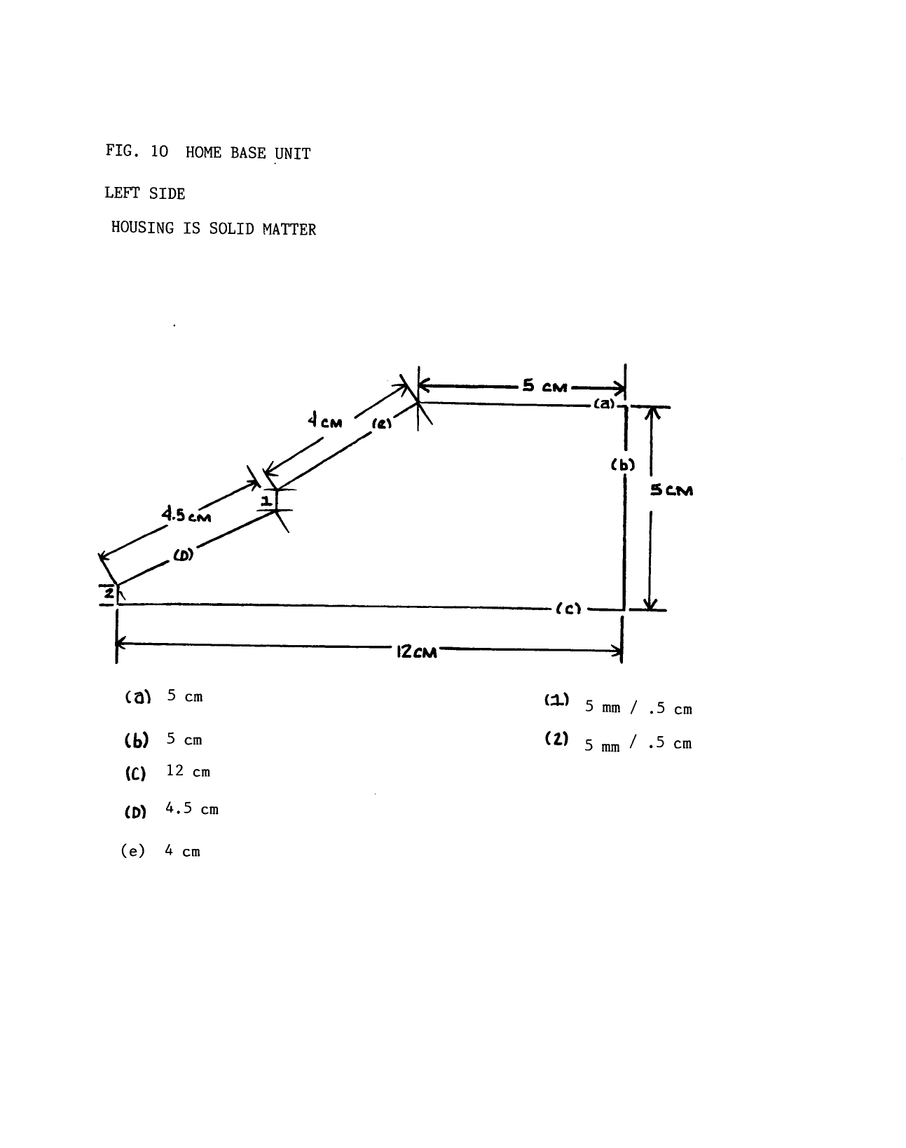

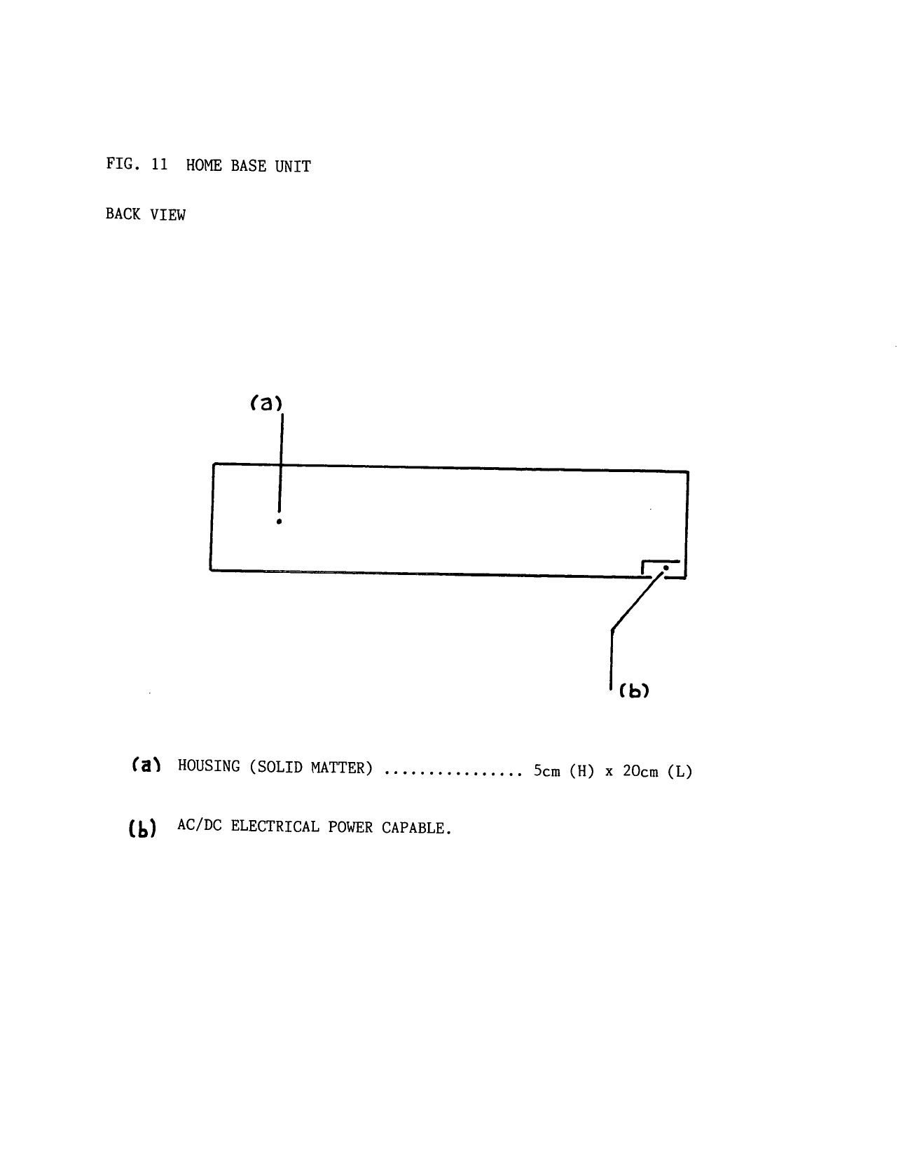

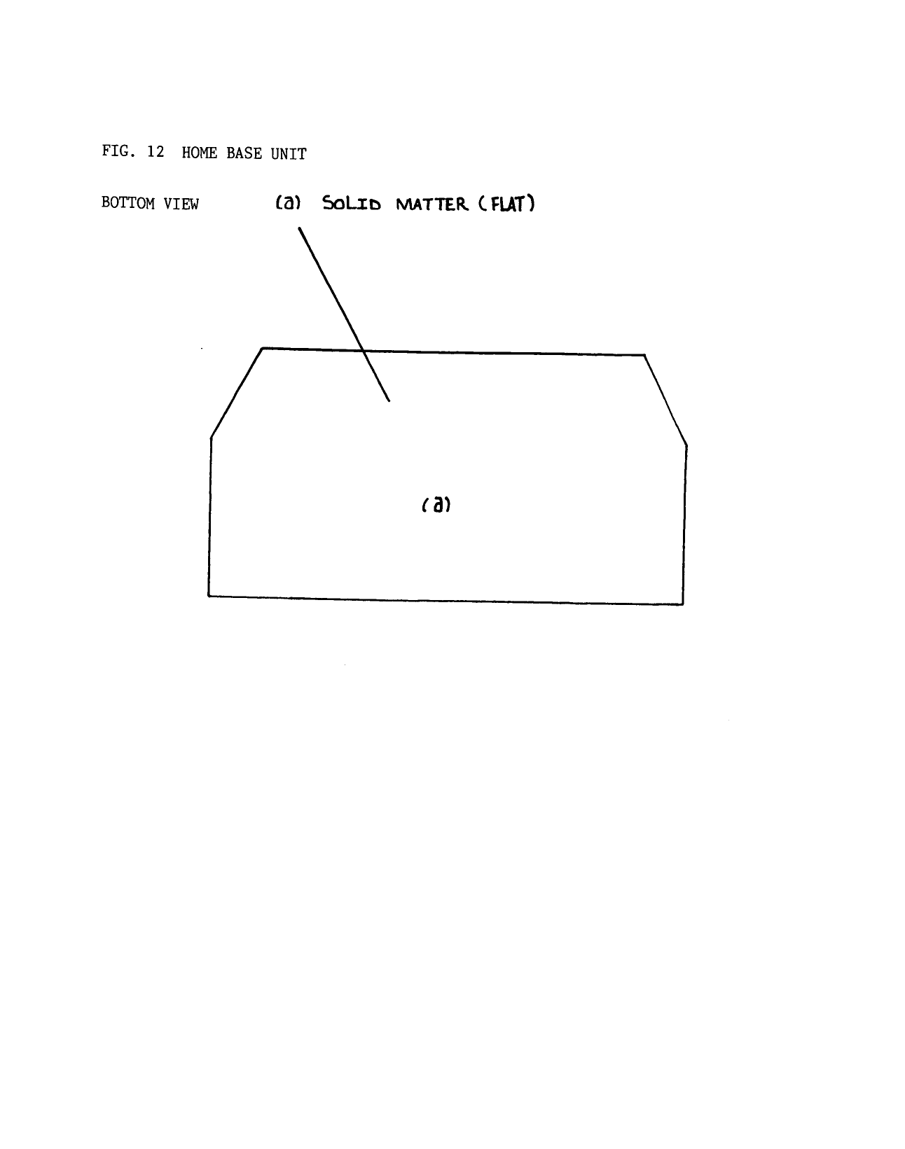

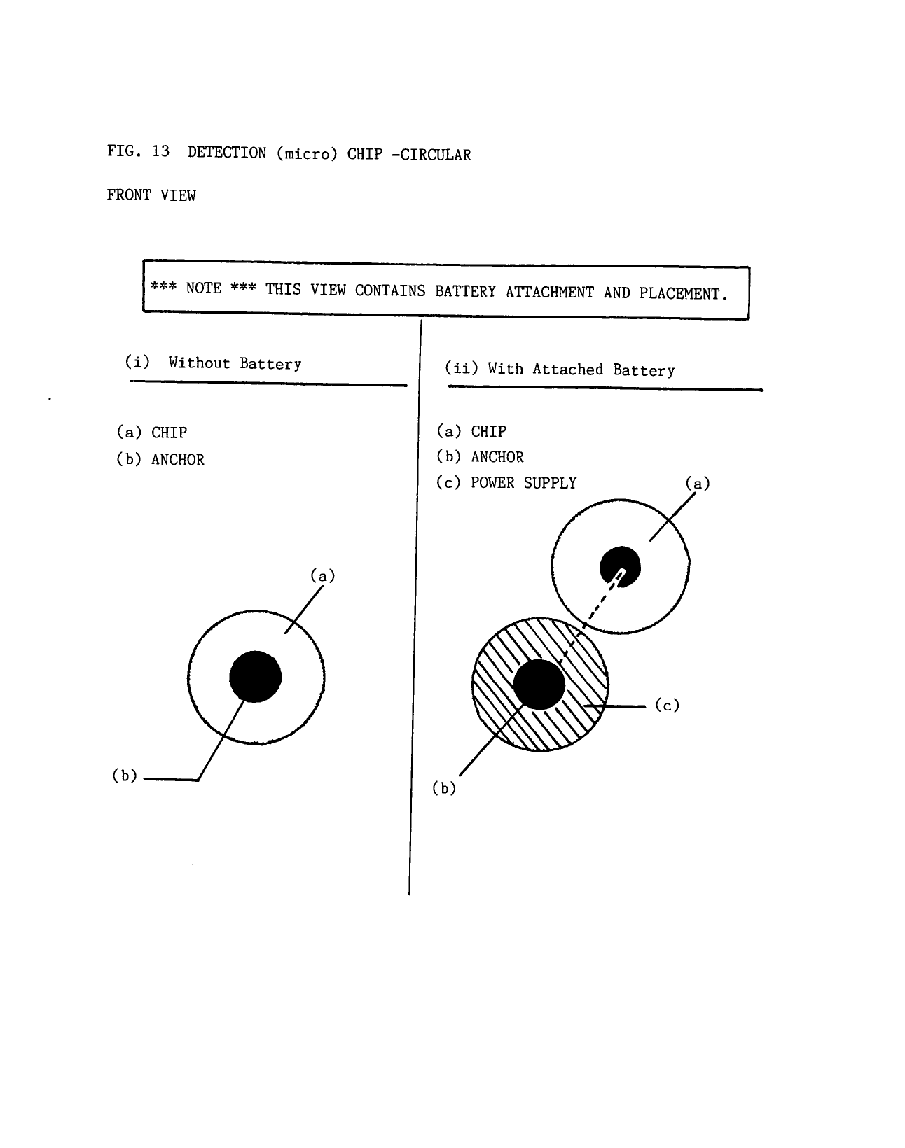

See FIG. 13 page 18 “Detection”

### 2. Invisiband—(Rectangle)

Composition Matter . . . Plastic/Flex fiber

a. SIZE: . . . 4 cm (L)

b. POWER SOURCE: . . . Internal . . . (Approx. 3.5 cm (L))

c. Thickness . . . Approx. 2 mm

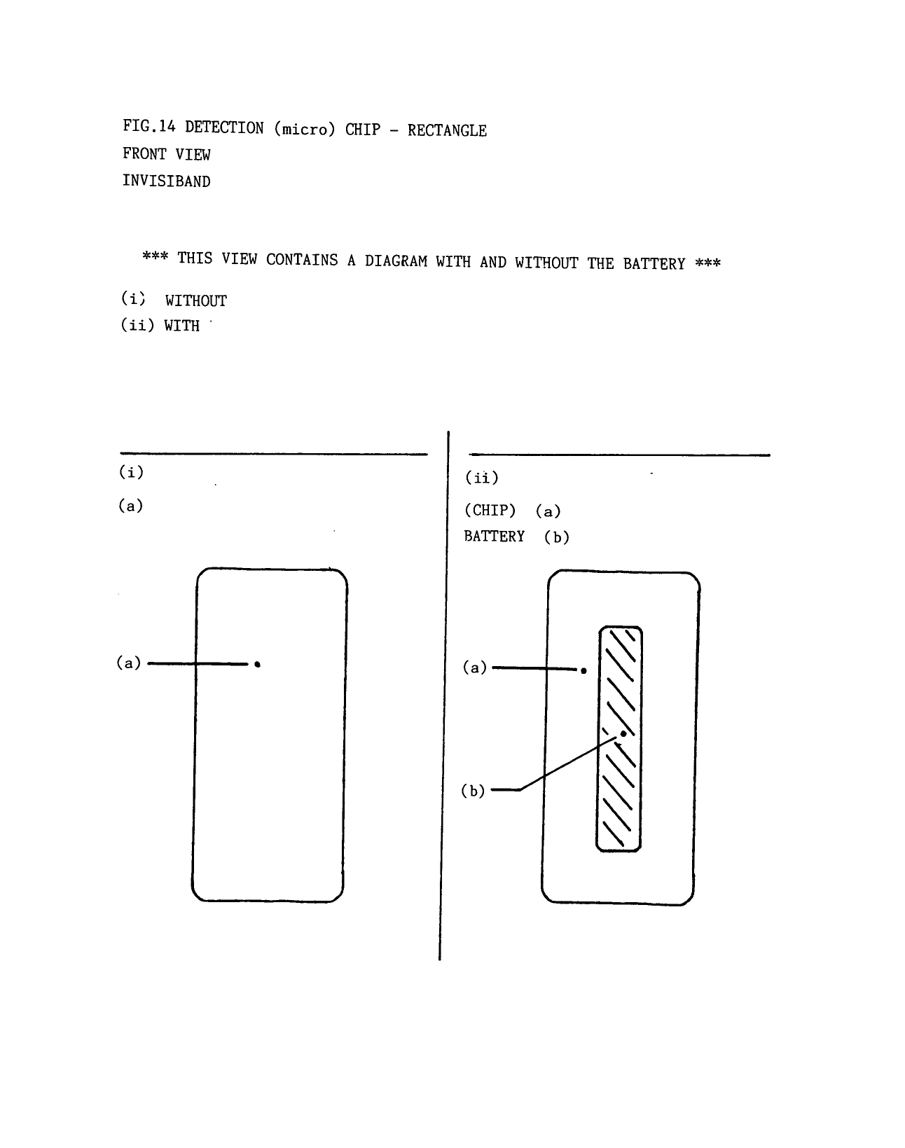

See FIG. 14 page 19

All matter is created and composed upon manufacture specification and EPA guidelines.

3. Manufacture Power Supplier: (Subjected to discretion).

e.g.—I. DURACELL CORP.

II. EVEREADY CORP.

III. INTERSTATE CORP.

IV. ENERGIZER CORP.

4. Each chip will be mass produced at a certified and reputable Technology center specializing in electronics and micro-chip creation and installation. (e.g.) HP, Celestica, NEC and Sony)

### Portable Device: (Hand Held Unit)

1. The following specifications will be used in conjunction with the hand held device.

### Creation:

a. plastic mode injection process will create the housing of the unit.

b. SCREEN: Plastic viewing screen (LCD) Liquid Crystal Display

c. ILLUMINATION: (LED) Light Emitting Diode

d. BUTTONS: the buttons will be made from foam rubber in pads.

Software: Pre-Installed: This device is equipped with tracking and location programs specifically designed to track each scanned chip.
Comparison: CALCULATOR (CASIO-fx-260 solar fraction)

U.S. Pat. Nos. 4,120,583, 4,121,284, 4,371,923, 4,396,976, 4,531,182 4,686,622, 4,829,419, 4,942,516.

**The above is only mentioned as comparison and is not intended** as infringement.

### Home Base Unit:

1. This unit is made from plastic mold injection and will be non-toxic and durable to withstand daily use and transportation.

a. SCEEN/WINDOW: LCD display and LED lighting.

b. BUTTONS: The buttons are made from durable foam rubber pads which are non toxic and meet federally approved requirments.

Software: pre-installed.

Other: This device is equipped with a tracking and location programmed designed for each scanned individual chip and is capable of storing information.

1. Portable hand held and home base tracking units CAPABILITIES: LOS-Line of Sight
GPS-Global positioning satellite

2. MICRO CHIPS: (i) CIRCULAR and (ii) RECTANGULAR CAPABILITIES: FLEXIBLE and NON toxic

3. The insertion of the chips into articles of clothing for security and individual protection, location and to aid in the recovery process of missing persons and or, child abductions.
